(19) United States
(12) Patent Application Publication
(10) Pub. No.: US 2024/0037389 A1
(43) Pub. Date: Feb. 1, 2024

(54) METHOD OF LEARNING NEURAL NETWORK, FEATURE SELECTION APPARATUS, FEATURE SELECTION METHOD, AND RECORDING MEDIUM

(71) Applicant: NEC Corporation, Tokyo (JP)

(72) Inventor: Masanao NATSUMEDA, Tokyo (JP)

(73) Assignee: NEC Corporation, Tokyo (JP)

(21) Appl. No.: 18/227,261

(22) Filed: Jul. 27, 2023

(30) Foreign Application Priority Data
Jul. 28, 2022 (JP) 2022-120681

(51) Int. Cl. G06N 3/08

(52) U.S. Cl. CPC G06N 3/08

(57) ABSTRACT

A method of learning a neural network, wherein the neural network includes: a feature selection layer for selecting a part of input data including information about a domain of each sample; a feature extraction layer for extracting a feature quantity on the basis of the selected input data; and a prediction layer for performing a prediction on the basis of the feature quantity, and the method includes adjusting a weight parameter of the neural network to increase a prediction accuracy by the prediction layer and to reduce a contribution to a prediction result of the prediction layer by the domain of the input data.

### INCORPORATION BY REFERENCE

This application is based upon and claims the benefit of priority from Japanese Patent Application No. 2022-120681, filed on Jul. 28, 2022, the disclosure of which is incorporated herein in its entirety by reference.

### TECHNICAL FIELD

Example embodiments of this disclosure relate to the technical fields of a method of learning a neural network, a feature selection apparatus, a feature selection method, and a recording medium.

### BACKGROUND ART

In a machine learning model, a part of a plurality of features included in input data may be selected and used. For example, Patent Literature 1 discloses that a variable useful for prediction and a variable that influences an intervention variable are selected to learn a model in order to optimize the prediction of an objective variable. Patent Literature 2 discloses that an identification model is created by a learning sample image, and an important feature is selected on the basis of an evaluation value obtained by evaluating each image by using the model. Patent Literature 3 discloses that the number of trials and errors of feature selection is reduced by using an orthogonal table used in an experimental design method.

### PRIOR ART DOCUMENTS

### Patent Literature

[Patent Literature 1] Japanese Patent No. 6708295
[Patent Literature 2] Japanese Patent No. 5777390
[Patent Literature 3] JP2016-31629A

### SUMMARY

This disclosure aims to improve the techniques/technologies disclosed in Prior Art Documents.

A method of learning a neural network according to an example aspect of this disclosure is a method of learning a neural network, wherein the neural network includes: a feature selection layer for selecting a part of input data including information about a domain of each sample; a feature extraction layer for extracting a feature quantity on the basis of the selected input data; and a prediction layer for performing a prediction on the basis of the feature quantity, and the method includes adjusting a weight parameter of the neural network to increase a prediction accuracy by the prediction layer and to reduce a contribution to a prediction result of the prediction layer by the domain of the input data.

A feature selection apparatus according to an example aspect of this disclosure is a feature selection apparatus that performs learning to adjust a weight parameter of a neural network to increase a prediction accuracy by a prediction layer and to reduce a contribution to a prediction result of the prediction layer by a domain of input data, and that selects a part of the input data by using the learned neural network, wherein the neural network includes: a feature selection layer for selecting a part of input data including information about a domain of each sample; a feature extraction layer for extracting a feature quantity on the basis of the selected input data; and the prediction layer for performing a prediction on the basis of the feature quantity.

A feature selection method according to an example aspect of this disclosure is a feature selection method including: performing learning to adjust a weight parameter of a neural network to increase a prediction accuracy by a prediction layer and to reduce a contribution to a prediction result of the prediction layer by a domain of input data; and selecting a part of the input data by using the learned neural network, wherein the neural network includes: a feature selection layer for selecting a part of input data including information about a domain of each sample; a feature extraction layer for extracting a feature quantity on the basis of the selected input data; and the prediction layer for performing a prediction on the basis of the feature quantity.

A recording medium according to an example aspect of this disclosure is a non-transitory recording medium on which a computer program that allows at least one computer to execute a method of learning a neural network is recorded, wherein the neural network includes: a feature selection layer for selecting a part of input data including information about a domain of each sample; a feature extraction layer for extracting a feature quantity on the basis of the selected input data; and a prediction layer for performing a prediction on the basis of the feature quantity, and the method includes adjusting a weight parameter of the neural network to increase a prediction accuracy by the prediction layer and to reduce a contribution to a prediction result of the prediction layer by the domain of the input data.

### BRIEF DESCRIPTION OF THE DRAWINGS

FIG. 1 is a block diagram illustrating a hardware configuration of a fault diagnosis system according to a first example embodiment;

FIG. 2 is a block diagram illustrating a functional configuration of the fault diagnosis system according to the first example embodiment;

FIG. 3 is a network structure diagram illustrating a configuration of a model provided by the fault diagnosis system according to the first example embodiment;

FIG. 4 is a flowchart illustrating a flow of an operation of learning a neural network;

FIG. 5 is a flowchart illustrating a flow of a model generation operation using learning data;

FIG. 6 is a network structure diagram illustrating a configuration of a model provided by a fault diagnosis system according to a second example embodiment;

FIG. 7 is a network structure diagram illustrating a configuration of a model provided by a fault diagnosis system according to a third example embodiment;

FIG. 8 is a flowchart illustrating a flow of a diagnosis operation by a fault diagnosis system according to a fourth example embodiment;

FIG. 9 is a conceptual diagram illustrating a prediction operation of predicting an attribute information by the fault diagnosis system according to the fourth example embodiment;

FIG. 10 is a diagram illustrating an example of the attribute information predicted by the fault diagnosis system according to the fourth example embodiment;

FIG. 11 is a block diagram illustrating a configuration of a feature selection apparatus according to a fifth example embodiment; and

FIG. 12 is a flow chart illustrating a flow of a feature selection operation by the feature selection apparatus according to the fifth example embodiment.

### EXAMPLE EMBODIMENTS

Hereinafter, a method of learning a neural network, a feature selection apparatus, a feature selection method, and a recording medium according to example embodiments will be described with reference to the drawings. The following describes an example in which the method of learning a neural network is executed in the neural network provided by a fault diagnosis system that diagnoses a fault or failure of a target device. In the method of learning the neural network according to the example embodiments can be applied to a system other than the fault diagnosis system or an apparatus.

### First Example Embodiment

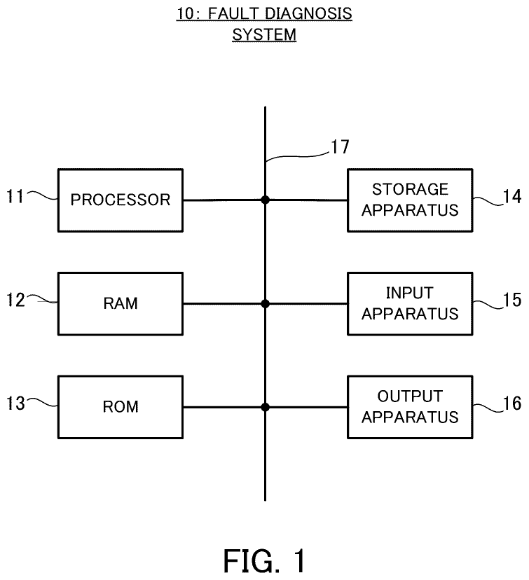

A fault diagnosis system according to a first example embodiment will be described with reference to FIG. 1 to FIG. 5.

### (Hardware Configuration)

First, a hardware configuration of the fault diagnosis system according to the first example embodiment will be described with reference to FIG. 1. FIG. 1 is a block diagram illustrating the hardware configuration of the fault diagnosis system according to the first example embodiment.

As illustrated in FIG. 1, a fault diagnosis system 10 according to the first example embodiment includes a processor 11, a RAM (Random Access Memory) 12, a ROM (Read Only Memory) 13, and a storage apparatus 14. The diagnosis system 10 may further include an input apparatus 15 and an output apparatus 16. The processor 11, the RAM 12, the ROM 13, the storage apparatus 14, the input apparatus 15 and the output apparatus 16 are connected through a data bus 17.

The processor 11 reads a computer program. For example, the processor 11 is configured to read a computer program stored by at least one of the RAM 12, the ROM 13 and the storage apparatus 14. Alternatively, the processor 11 may read a computer program stored in a computer-readable recording medium by using a not-illustrated recording medium reading apparatus. The processor 11 may obtain (i.e., may read) a computer program from a not-illustrated apparatus disposed outside the fault diagnosis system 10, through a network interface. The processor 11 controls the RAM 12, the storage apparatus 14, the input apparatus 15, and the output apparatus 16 by executing the read computer program. Especially in this example embodiment, when the processor 11 executes the read computer program, a functional block for learning a neural network is realized or implemented in the processor 11. That is, the processor 11 may function as a controller for performing each control in learning the neural network.

The processor 11 may be configured as a CPU (Central Processing Unit), a GPU (Graphics Processing Unit), a FPGA (field-programmable gate array), a DSP (Demand-Side Platform) or an ASIC (Application Specific Integrated Circuit), for example. The processor 11 may include one of them, or may use a plurality of them in parallel.

The RAM 12 temporarily stores the computer program to be executed by the processor 11. The RAM 12 temporarily stores the data that is temporarily used by the processor 11 when the processor 11 executes the computer program. The RAM 12 may be, for example, a D-RAM (Dynamic Random Access Memory) or a SRAM (Static Random Access Memory). Another type of volatile memory may also be used in place of the RAM 12.

The ROM 13 stores the computer program to be executed by the processor 11. The ROM 13 may otherwise store fixed data. The ROM 13 may be, for example, a P-ROM (Programmable Read Only Memory) or an EPROM (Erasable Read Only Memory. Another type of non-volatile memory may also be used in place of ROM 13.

The storage apparatus 14 stores the data that is stored for a long term by the fault diagnosis system 10. The storage apparatus 14 may operate as a temporary storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the fault diagnosis system 10. The input apparatus 15 may include, for example, at least one of a keyboard, a mouse, and a touch panel. The input apparatus 15 may be configured as a portable terminal, such as a smartphone and a tablet. The input apparatus 15 may be an apparatus that allows an audio input including a microphone, for example.

The output apparatus 16 is an apparatus that outputs information about the failure diagnostic device 10 to the outside. For example, the output apparatus 16 may be a display apparatus (e.g., a display) that is configured to display the information about the fault diagnosis system 10. Furthermore, the output apparatus 16 may be a speaker that audio-outputs the information about the fault diagnosis system 10. The output apparatus 16 may be configured as a portable terminal, such as a smartphone or a tablet. Furthermore, the output apparatus 16 may be an apparatus that outputs the information in a format other than an image. For example, the output apparatus 16 may be a speaker that audio-outputs the information about the fault diagnosis system 10.

FIG. 1 exemplifies the fault diagnosis system 10 including a plurality of apparatuses, but all or a part of the functions may be realized as a single apparatus (i.e., a fault diagnosis apparatus). In this case, the fault diagnosis apparatus may include only the processor 11, the RAM 12, and the ROM 13, for example, and the other components (i.e., the storage apparatus 14, the input apparatus 15, and the output apparatus 16) may be provided for an external apparatus connected to the fault diagnosis apparatus. In addition, in the fault diagnosis system, a partial arithmetic function may be realized or implemented by an external apparatus (e.g., an external server or a cloud, etc.).

### (Functional Configuration)

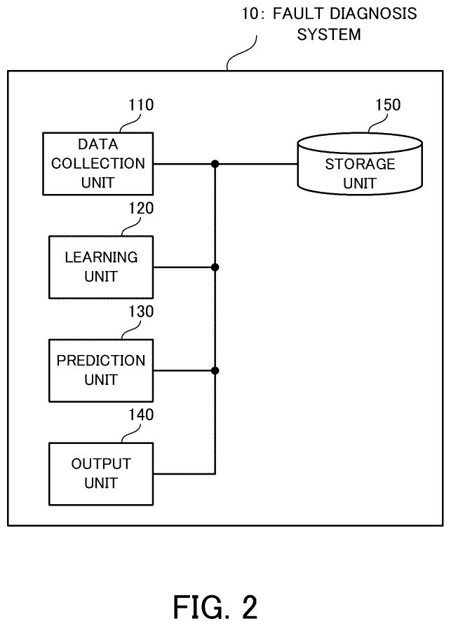

Next, with reference to FIG. 2, a functional configuration of the fault diagnosis system 10 according to the first example embodiment will be described. FIG. 2 is a block diagram illustrating the functional configuration of the fault diagnosis system according to the first example embodiment.

As illustrated in FIG. 2, the fault diagnosis system 10 according to the first example embodiment includes, as components for realizing the functions thereof, a data collection unit 110, a learning unit 120, a prediction unit 130, an output unit 140, and a storage unit 150. Each of the data collection unit 110, the learning unit 120, the prediction unit 130, and the output unit 140 may be a processing block that is realized or implemented by the processor 11 (see FIG. 1), for example. Furthermore, the storage unit 150 may be realized or implemented by the storage apparatus 14 (see FIG. 1), for example.

The data collection unit 110 is configured to collect data indicating a state of a target device. The data may be time series operation data obtained from the target device. The type of the target device is not particularly limited, but an example thereof includes a hard disk, an NAND flash memory, or a rotating device (e.g., a pump, a fan, etc.). In the case of the hard disk, the time series data may include Write Count, Average Write Response Time, Max Write Response Time, Write Transfer Rate, Read Count, Average Read Response Time, Max Read Time, Read Transfer Rate, Busy Ratio, Busy Time, or the like. In the case of the NAND flash memory, the time series data may include a rewrite number, a rewrite interval, a read number, temperature in a use environment, an error rate, information about a manufacturing maker, and information about a manufacturing lot, as well as information about an error correction coding (ECC) performance of a memory controller that performs an ECC process on the NAND flash memory. In the case of the rotating device, the time series data may include an output value of a strain gage, torque of a motor, current, an ultrasonic wave (AE sensor), and acceleration sensor, or the like.

The learning unit 120 is configured to learn a model for diagnosing a fault or failure of the target device, by using the time series data collected by the data collection unit 110 as learning data. The learning data may be, for example, a sample set in which a pair of the time series data and a label (e.g., information indicating a failure type) is used as a sample. The model learned by the learning unit 120 may include a neural network. The structure of the model to be learned and a specific learning method will be described in detail later.

The prediction unit 130 is configured to perform a prediction based on input data, by using the model learned by the learning unit 120. For example, the prediction unit 130 is configured to predict information about the fault or failure of the target device (e.g., a failure type or occurrence timing, etc.), with the time series data about the target device as an input.

The output unit 140 is configured to be output various information in the fault diagnosis system 10. For example, the output unit 140 may be configured to output a prediction result of the prediction unit 130. For example, the output unit 140 may output the information about the fault or failure of the target device. Alternatively, the output unit 140 may output an alarm or a countermeasure corresponding to the fault or failure of the target device (e.g., a warning for prompting maintenance) or the like. The output unit 140 may be configured to output various information through the output apparatus 16. For example, the output unit 140 may be configured to output various information through a monitor, a speaker, or the like.

The storage unit 150 is configured to store various information handled by the fault diagnosis system 10. The storage unit 150 may be configured to store the model learned by the learning unit 120, for example. The storage unit 150 may be configured to store the data about the target device collected by the data collection unit 110.

### (Model Structure)

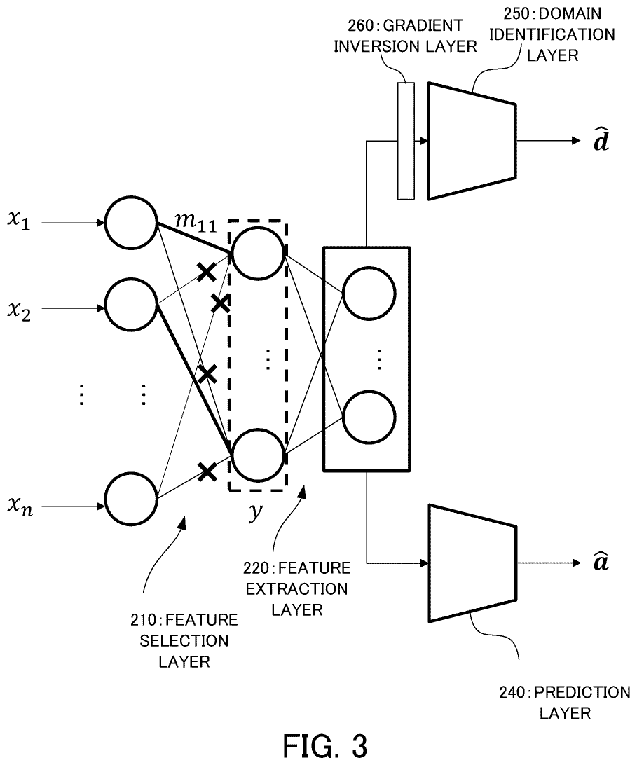

Next, with reference to FIG. 3, a structure of a model (neural network) provided by the fault diagnosis system 10 according to the first example embodiment will be described. FIG. 3 is a network structure diagram illustrating a configuration of the model provided by the fault diagnosis system according to the first example embodiment.

As illustrated in FIG. 3, the neural network provided by the fault diagnosis system 10 according to the first example embodiment includes a feature selection layer 210, a feature extraction layer 220, and a prediction layer 240. The neural network may include a layer other than the feature selection layer 210, the feature extraction layer 220, and the prediction layer 240.

The feature selection layer 210 selects and outputs apart of the input data. The selection of a feature by feature selection layer 210 is controlled by a temperature T∈(0,∞). For example, when the temperature T is very high, various features are equally selected in the feature selection layer 210, but as the temperature T decreases, the selection is biased. The temperature T is changed in a preset range (e.g., 10 to 0.01, etc.) during the learning described later. The feature selection layer 210 outputs M(T)^{T}ₓ when input data x is inputted. Each element mᵢⱼ(T)∈[0,1] in an i-th row and a j-th column included in M(T) is defined as in Equation (1) below.

$$\begin{matrix}[ Equation 1 ] & \\ {m}_{i j} ( T ) = \frac{exp ( ( log {α}_{i j} + {g}_{i j} ) / T )}{{\sum }_{h = 1}^{c} exp {( ( log {α}_{h j} + {g}_{h j} ) / T )}^{′}} & ( 1 )\end{matrix}$$

wherein αᵢⱼ is a weight parameter determined by the learning, and gᵢⱼ is an independent sample from the Gumbel distribution.

The feature extraction layer 220 extracts a feature quantity on the basis of the input data selected in the feature selection layer 210. The feature quantity extracted in the feature extraction layer 220 is configured to be outputted to the prediction layer 240

The prediction layer 240 performs a prediction on the basis of the feature quantity extracted in the feature extraction layer 220. A prediction result of the prediction layer 240 may be, for example, an attribution information about the fault or failure of the target device. In this case, the fault diagnosis system 10 may be configured to diagnose the fault or failure of the target device on the basis of the attribute information. The fault diagnosis using the attribute information will be described in detail in another example embodiment described later.

A domain identification layer 250 identifies a domain of the input data given from a plurality of domains. The input data include information about the domain of each sample, and the domain identification layer 250 identifies from which domain each sample included in the input data is derived.

A gradient inversion layer 260 is a layer for inverting a positive and negative sign of a loss term for the identification of the domain, when a weight parameter is updated by an error back propagation method. The purpose of inversing the positive and negative sign of the loss term will be described in detail later.

The model described above may include various auto encoders. For example, when the input data are time series data, a self-encoding model for the time series data, such as LSTM Autoencoder, may be used. Alternatively, variants of Autoencoder, such as Denoising Autoencoder and Variational Autoencoder, may be used.

### (Learning Operation)

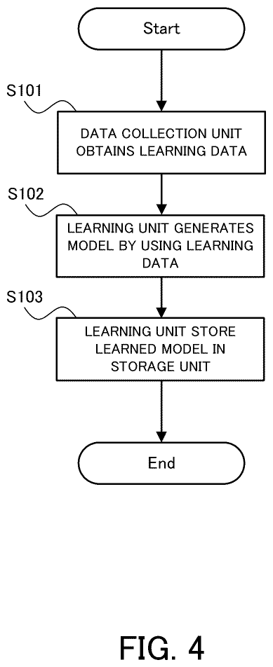

Next, a learning operation by the fault diagnosis system 10 according to the first example embodiment (i.e., an operation when learning the model for diagnosing the fault or failure) will be described with reference to FIG. 4. FIG. 4 is a flowchart illustrating a flow of the operation of learning the neural network.

As illustrated in FIG. 4, when the operation of learning the neural network in the fault diagnosis system 10 according to the first example embodiment is started, first, the data collection unit 110 obtains the learning data (step S101). The data collection unit 110 obtains, for example, operation data about the target device, as the learning data. At this time, the data collection unit 110 may newly collect the learning data from the target device, or may obtain the learning data collected in the past from the storage unit 150. The learning data obtained by the data collection unit 110 are outputted to the learning unit 120.

Subsequently, the learning unit 120 learns the model for diagnosing the fault or failure of the target device, by using the learning data (step S102). A method of learning the model by the learning unit 120 will be described in detail later. When the learning is ended, the learning unit 120 stores the learned model in the storage unit 150 (step S103). When the fault diagnosis system 10 is operated, the fault diagnosis is performed by using the learned model stored here in the storage unit 150.

### (Flow of Learning Method)

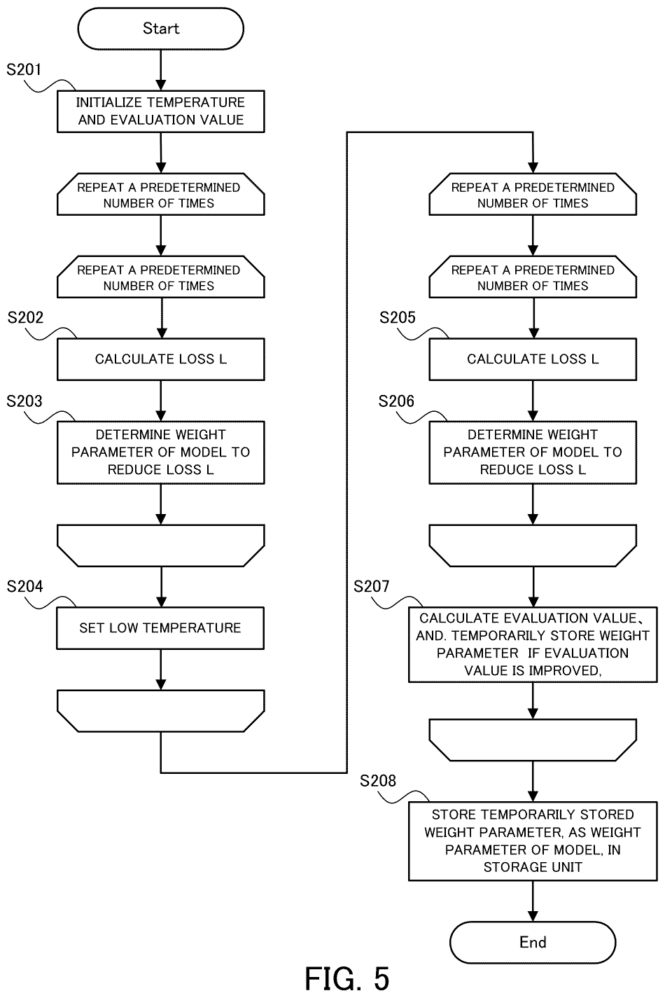

Next, with reference to FIG. 5, a flow of the method of learning the neural network (specifically, the S102 described in FIG. 4) performed by the fault diagnosis system 10 according to the first example embodiment will be described in detail. FIG. 5 is a flowchart illustrating a flow of a model generation operation using the learning data.

As illustrated in FIG. 5, in the learning method of the neural network executed by the fault diagnosis system 10 according to the first example embodiment, first, the learning unit 130 initializes a temperature and an evaluation value (step S201). The temperature here is a parameter for controlling the selection in the feature selection layer 210, as already described. The evaluation value is a value for determining whether or not to update the weight parameter of the model, and may be a value including a loss L, for example. Initial values of the temperature and the evaluation value may be set in advance.

The learning unit 130 calculates the loss L on the basis of an output when the learning data are inputted to the model (step S202). A method of calculating the loss L will be described in detail later. Subsequently, the learning unit 130 determines the weight parameter of the model to reduce the loss L (step S203). The learning unit 130 repeats the steps S202 and S203 a predetermined number of times.

Then, the learning unit 130 sets a low temperature T (step S204). That is, the value of the temperature T used so far is lowered. Then, the steps S202 and S203 are repeated a predetermined number of times, while the temperature T is lowered. In this way, the learning in the steps S202 and S203 is repeated at low temperature. The temperature T may be exponentially lowered. In addition, an updating range of the temperature T is determined such that the temperature at which first-stage learning described later is ended, is a final temperature Te.

By repeating the process up to S204 described above, the temperature T becomes the final temperature Te. A learning process until the temperature T becomes the final temperature Te is referred to as first-stage learning. The learning unit 130 performs the first-stage learning, followed by second-stage learning. The second-stage learning is performed with the temperature T fixed at the final temperature Te.

In the second-stage learning, the learning unit 130 calculates the loss L on the basis of the output when the learning data are inputted to the model (step S205). Subsequently, the learning unit 130 determines the weight parameter of the model to reduce the loss L (step S206). The learning unit 130 repeats the steps S205 and S206 a predetermined number of times.

Then, the learning unit 130 calculates the evaluation value. If the calculated evaluation value is improved, the weight parameter at that time is temporarily stored (step S207). Then, the learning unit 130 repeats the steps S205 and S206 a predetermined number of times. By performing the learning in this way, it is possible to improve prediction accuracy in the prediction layer 240.

When the learning is ended, the learning unit 130 stores the temporarily stored weight parameter (i.e., the weight parameter stored in the step S207), as the weight parameter of the model, in the storage unit 150 (step S208).

### (Calculation of Loss)

Next, the loss L used in the learning method will be specifically described. Of the weight parameter of the neural network according to this example embodiment, the loss L of the weight parameter of a part excluding the domain identification layer 250 is defined as in Equation (2) below.

[Equation 2]

L=L_{c}+λ₂L_{dpl}−λ₃L_{d} (2)

In Equation (2), λ₂ and λ₃ are hyperparameters. In the learning of the model, λ₂ and λ₃ may be fixed values, or may be variable values. For example, λ₂ and λ₃ may be gradually increased from 0, as the learning progresses. In this case, a change in weight may be different for each regularization term.

L_{C} is a loss function of the predictor stratum 140 and is defined as in Equation (3) below.

[Equation 4]

L_{c}=BCE(α,\hat{α}), (3)

wherein BCE is the Binary Cross-Entropy function, a is an actual value, and a\hat{ } is an attribute (a predicted value) predicted in the prediction layer 140. Since the loss L includes L_{C} described above, the model is learned to improve the prediction accuracy by the prediction layer 240.

L_{dpl} is a penalty term for prompting the feature selection layer 210 to select different features, and is defined as in Equation (4) below.

$$\begin{matrix}[ Equation 4 ] & \\ {L}_{dpl} = {\sum }_{i = 1}^{c} max ( {\sum }_{j = 1}^{k} {{m}^{'}}_{i j} ( T ) - τ , 0 ) , & ( 4 )\end{matrix}$$

wherein τ is a hyperparameter for controlling a degree of penalty, and is usually set as a value of 1 or more. In the learning of the model, τ may be a constant value. Furthermore, L_{dpl} may be defined as in Equation (5) below, such that τ may vary depending on the temperature T.

$$\begin{matrix}[ Equation 5 ] & \\ {L}_{dpl} = {\sum }_{i = 1}^{c} max ( {\sum }_{j = 1}^{k} {p}_{i j} - τ , 0 ) , & ( 5 )\end{matrix}$$

Here, pᵢⱼ is defined as in Equation (6) below.

$$\begin{matrix}[ Equation 6 ] & \\ {p}_{i j} = \frac{{α}_{i j}}{{\sum }_{h = 1}^{c} {α}_{h j}} & ( 6 )\end{matrix}$$

When the temperature T is lowered as the learning progresses, τ may also be reduced to match the temperature T. For example, when the temperature T is exponentially lowed, τ may also be exponentially reduced.

L_{d} is a loss function (cross-entropy) of the domain identification layer 250. L_{d} is defined as in Equation (7) below, for example.

[Equation 10]

L_{d}=BCE(d,\hat{d}), (7)

The domain identification layer 250 is learned to reduce L_{d}. This improves identification accuracy of the domain. On the other hand, since the gradient inversion layer 260 is inserted in a previous stage of the domain identification layer 250, the weight parameters of the feature selection layer 210 and the feature extraction layer 220 are learned to reduce the identification accuracy of the domain. For this reason, the losses L of the entire model are combined into a loss L′ that is defined as in Equation (8) below.

[Equation 8]

L′=L_{c}+λ₂L_{dpl}+λ₃L_{d} (8)

As described above, by inverting the sign of the loss function of the domain identification layer 250, the weight parameters of the feature selection layer 210 and the feature extraction layer 220 are learned to increase the loss of the domain identification layer 250. In other words, the learning is performed to extract the feature that deceives the domain identification layer 250. If there is no gradient inversion layer 260, it is necessary to sequentially update the parameter, while limiting the parameter serving as an update target, by using the loss L of the Equation (2) and the loss function (λ₃L_{d}) of the domain identification layer 250. In this example embodiment, however, the two loss functions can be combined into one loss function, as described above, and it is thus possible to perform the learning, more easily.

### Technical Effect

Next, a technical effect of the learning method of the neural network executed in the fault diagnosis system 10 according to the first example embodiment will be described.

As described in FIG. 1 to FIG. 5, in the fault diagnosis system 10 according to the first example embodiment, the learning is performed to increase the prediction accuracy of the prediction layer 240 and to increase the identification accuracy by the domain identification layer 250. Then, the learning is performed such that the feature quantity extracted through the feature selection layer 210 and the feature extraction layer 220 is unsuccessfully identified in the domain identification layer 250. In this way, it is possible to reduce an influence (contribution) of the domain on the prediction result. Consequently, it is possible to realize the prediction that does not depend on the domain of the input data.

### Second Example Embodiment

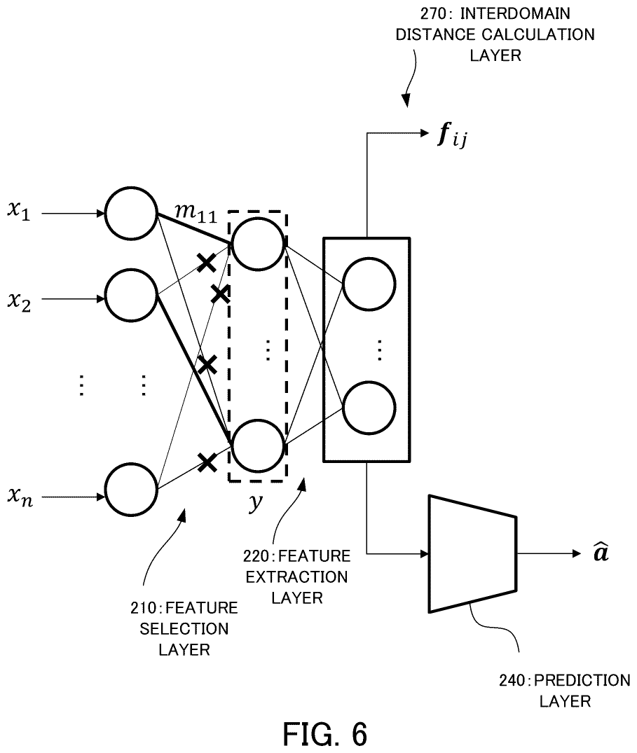

The fault diagnosis system 10 according to a second example embodiment will be described with reference to FIG. 6. The second example embodiment is partially different from the first example embodiment only in the model structure and the learning method, and may be the same as the first example embodiment in the other parts. For this reason, a part that is different from the first example embodiment described above will be described in detail below, and a description of other overlapping parts will be omitted as appropriate.

### (Model Structure)

First, with reference to FIG. 6, a structure of a model (neural network) provided by the fault diagnosis system 10 according to the second example embodiment will be described. FIG. 6 is a network structure diagram illustrating a configuration of the model provided by the fault diagnosis system according to the second example embodiment. In FIG. 6, the same components as those illustrated in FIG. 3 carry the same reference numerals.

As illustrated in FIG. 6, the neural network provided by the fault diagnosis system 10 according to the second example embodiment includes the feature selection layer 210, the feature extraction layer 220, the prediction layer 240, and an interdomain distance calculation layer 270. That is, the neural network according to the second example embodiment further includes the interdomain distance calculation layer 270, in place of the domain identification layer 250 and the gradient inversion layer 260 in the first example embodiment (see FIG. 3).

The interdomain distance calculation layer 270 calculates an interdomain distance of each sample of the input data (MMD: Maximum Mean Discrepancy). An interdomain distance Lₘ is defined as in Equation (9) below.

$$\begin{matrix}[ Equation 9 ] & \\ {L}_{m} = \frac{1}{2 D ( D - 1 )} {\sum }_{1 \leq d \leq D - 1} {\sum }_{d + 1 \leq k \leq D} M M D ( {f}_{d} , {f}_{k} ) & ( 9 )\end{matrix}$$

### (Calculation of Loss)

Next, the loss L in the learning of the neural network according to the second example embodiment will be specifically described. The loss L calculated in the second example embodiment is defined as in Equation (10) below.

[Equation 10]

L=L_{c}+λ₂L_{dpl}+λ₄Lₘ (10)

That is, the loss L according to the second example embodiment is obtained by adding λ₄Lₘ in place of λ₃L_{d} in the loss L described in the first example embodiment (see Equation (2) described above). Here, λ₄ is a hyperparameter, and Lₘ is the interdomain distance calculated by the interdomain distance calculation layer 270. As described above, the interdomain distance Lₘ calculated by the interdomain distance calculation layer 270 is considered in the loss L according to the second example embodiment. Specifically, the model is learned to reduce the interdomain distance Lₘ (in other words, to maximize a degree of similarity between the domains).

### Technical Effect

Next, a technical effect of the learning method of the neural network executed in the fault diagnosis system 10 according to the second example embodiment will be described.

In the fault diagnosis system 10 according to the second example embodiment, the learning is performed to reduce the interdomain distance. In this way, the degree of similarity between the domains is maximized, and substantially, a domain difference is not considered. It is thus possible to reduce the influence (contribution) of the domain on the prediction result. Consequently, it is possible to realize the prediction that does not depend on the domain of the input data.

The first example embodiment (see FIG. 3) and the second example embodiment (see FIG. 6) may be realized in combination. Specifically, the weight parameter of the domain identification layer 250 may be adjusted to increase the identification accuracy of the domain identification layer 250, and the weight parameters of the feature selection layer 210 and the feature extraction layer 220 may be adjusted to reduce the identification accuracy of the domain identification layer 250 and to increase the degree of similarity between the domains calculated by the interdomain distance calculation layer 270. Even when the first example embodiment and the second example embodiment are combined in this manner, it is possible to realize the prediction that does not depend on the domain of the input data.

### Third Example Embodiment

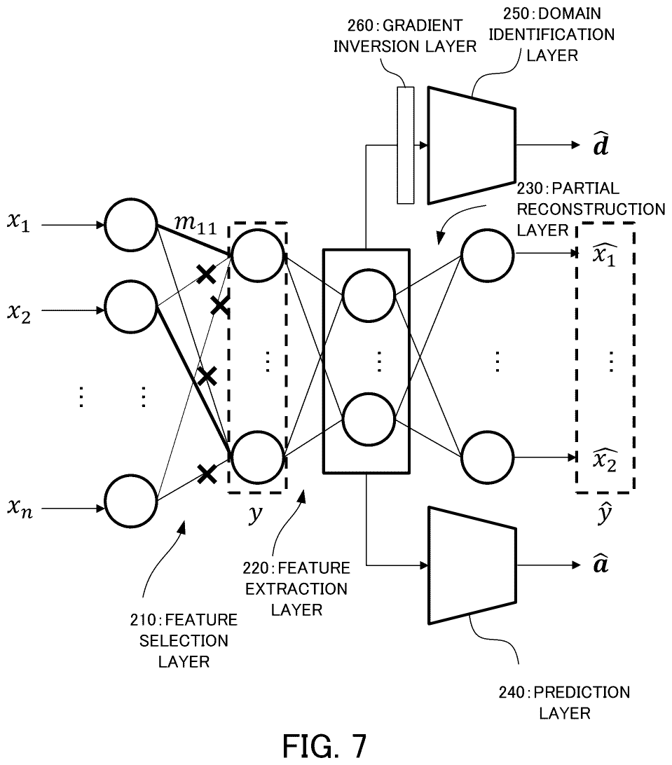

The fault diagnosis system 10 according to a third example embodiment will be described with reference to FIG. 7. The third example embodiment is partially different from the first and second example embodiments only in the model structure and the learning method, and may be the same as the first and second example embodiments in the other parts. For this reason, a part that is different from each of the example embodiments described above will be described in detail below, and a description of other overlapping parts will be omitted as appropriate.

### (Model Structure)

First, with reference to FIG. 7, a structure of a model (neural network) provided by the fault diagnosis system 10 according to the third example embodiment will be described. FIG. 7 is a network structure diagram illustrating a configuration of the model provided by the fault diagnosis system according to the third example embodiment. In FIG. 7, the same components as those illustrated in FIG. 3 carry the same reference numerals.

As illustrated in FIG. 7, the neural network provided by the fault diagnosis system 10 according to the third example embodiment includes the feature selection layer 210, the feature extraction layer 220, a partial reconstruction layer 230, the prediction layer 240, the domain identification layer 250, the gradient inversion layer 260, and the interdomain distance calculation layer 270. That is, the neural network according to the third example embodiment further includes the partial reconstruction layer 230, in addition to the configuration in the first example embodiment (see FIG. 3).

The partial reconstruction layer 230 reconstructs the input data selected in the feature selection layer 210, from the feature quantity extracted in the feature quantity extraction layer 220. That is, the partial reconstruction layer 230 partially reconstructs the selected part of the input data, rather than all the input data. The partial reconstruction layer 230 performs the reconstruction on the basis of a target feature quantity y=W(T_{c})^{T}ₓ). The target feature quantity y is determined in the learning. An element wij(T) in an i-th row and a j-th column of W(T) is defined as in Equations (11a) and (11b) below.

$$\begin{matrix}[ Equation 11 ] & \\ {w}_{i j} ( T ) = \{ \begin{matrix}1 , & i = arg {max}_{h} {{m}^{'}}_{hj} ( T ) ; \\ 0 , & otherwise .\end{matrix} & \begin{matrix}( 11 a ) \\ ( 11 b )\end{matrix}\end{matrix}$$

### (Calculation of Loss)

Next, the loss L in the learning of the neural network according to the third example embodiment will be specifically described. The loss L calculated in the third example embodiment is defined as in Equation (12) below.

[Equation 12]

L=L_{c}+λ₁Lₐₑ+λ₂L_{dpl}+λ₃L_{d} (12)

That is, the loss L according to the third example embodiment is obtained by adding λ₁Lₐₑ to the loss L described in the first example embodiment (see Equation (3) described above). Here, λ₁ is a hyperparameter. Furthermore, Lₐₑ is a loss function of the partial reconstruction layer 230 and is defined as in Equation (13) below.

[Equation 13]

Lₐₑ= [symbol] [∥y−ŷ∥₂²], (13)

wherein E[•] is a function that takes an expected value, and y and y\hat{ } are random variables corresponding to a measured value and a predicted value.

Lₐₑ is a value corresponding to a reconstruction error in the partial reconstruction layer 230, and the value is smaller as an original value can be more accurately restored, for example. Since the loss L includes Lₐₑ, the model is learned on the basis of the reconstruction error in the partial reconstruction layer 230, in addition to the prediction accuracy by the prediction layer 240 and the identification accuracy of the domain identification layer 250.

### Technical Effect

Next, a technical effect of the method of learning the neural network executed in the fault diagnosis system 10 according to the third example embodiment will be described.

In the fault diagnosis system 10 according to the third example embodiment, the learning is performed on the basis of the reconstruction error in the partial reconstruction layer 230, while reducing the influence (contribution) of the domain on the prediction result. In this way, it is possible to adjust the weight parameter such that the feature useful for the prediction in the prediction layer 240 is selected in the feature selection layer 210. As a result, it is possible to generate a model that is robust to a change in the distribution of feature quantities (i.e., a model with a high generalization performance).

The third example embodiment describes an example in which the partial reconstruction layer 230 is added to the model structure in the first example embodiment (see FIG. 3), but the partial reconstruction layer 230 may be added to the model structure in the second example embodiment. Even in this case, it is possible to improve the generalization performance of the model in the same manner.

### Fourth Example Embodiment

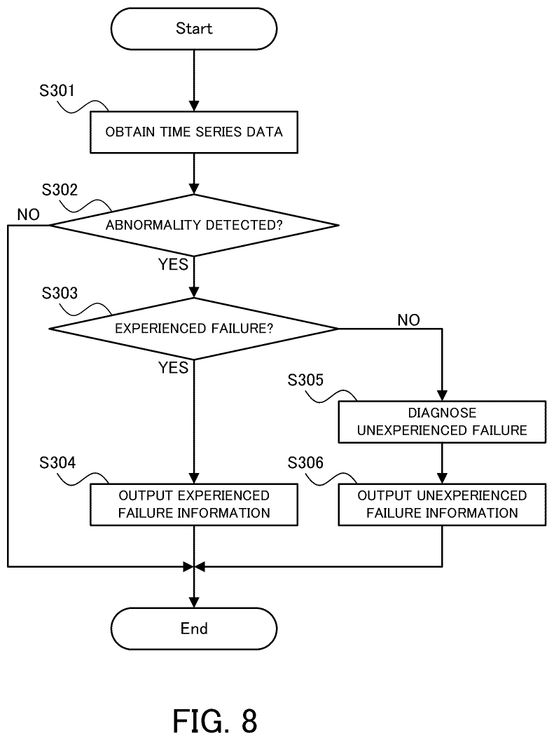

The fault diagnosis system 10 according to a fourth example embodiment will be described with reference to FIG. 8 to FIG. 10. The fourth example embodiment is partially different from the first to third example embodiments only in the configuration and operation, and may be the same as the first to third example embodiments in the other parts. For this reason, a part that is different from each of the example embodiments described above will be described in detail below, and a description of other overlapping parts will be omitted as appropriate.

### (Fault Diagnosis Operation)

First, a fault diagnosis operation (i.e., an operation of diagnosing the fault or failure of the target device by using the learned model) performed by the fault diagnosis system 10 according to the fourth example embodiment will be described with reference to FIG. 8. FIG. 8 is a flowchart illustrating a flow of the diagnosis operation performed by the fault diagnosis system according to the fourth example embodiment.

As illustrated in FIG. 8, in the fault diagnosis system 10 according to the fourth example embodiment, first, the data collection unit 110 obtains the time series data about the target device (step S301). The time series data obtained by the data collection unit 110 are outputted to the prediction unit 130.

Subsequently, the predicting unit 130 determines whether or not there is an abnormality in the target device on the basis of the time series data obtained by the data collection unit 110 (step S302). When there is no abnormality (S302: NO), the subsequent process may be omitted.

When there is an abnormality (step S302: YES), the predicting unit 130 determines whether or not the abnormality is caused by an experienced failure (i.e., a failure that has occurred in the target device in the past) (step S303). Then, when the abnormality is caused by the experienced failure (step S303: YES), the output unit 140 outputs information about the experienced failure (e.g., a failure type, a countermeasure, etc.) (step S304).

On the other hand, when the abnormality is not caused by the experienced failure (step S303: NO), the prediction unit 130 further diagnoses an unexperienced failure (i.e., a failure that has not occurred in the target device in the past) (step S305). Then, the output unit 140 outputs information based on a diagnostic result of the unexperienced failure (e.g., a failure type and a countermeasure of the unexperienced failure, etc.) (step S306).

As described above, in the fault diagnosis system 10 according to this example embodiment, it is possible to diagnose even the unexperienced failure, in addition to the experienced failure. The detection of an abnormality in the S302 may use an outlier detection technique/technology using machine-learning, for example. An identifier that has learned the experienced failure(s) in the step S303 for each type of the failure(s) may be used. When any identifier does not identify the failure, it may be determined that the abnormality is an unexperienced failure. The diagnosis of the unexperienced failure can be performed by using the model described in the first to third example embodiments. The diagnosis of the unexperienced failure will be described in more detail below.

(Attribute Information about Fault or Failure)

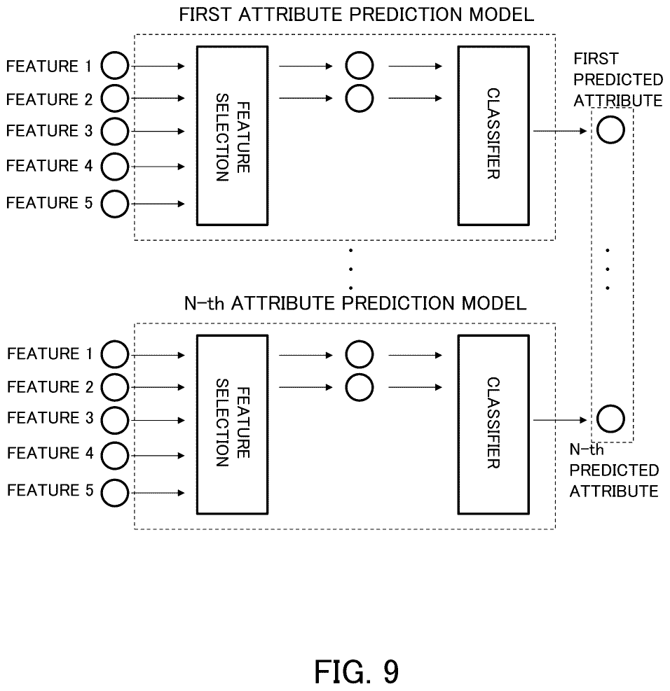

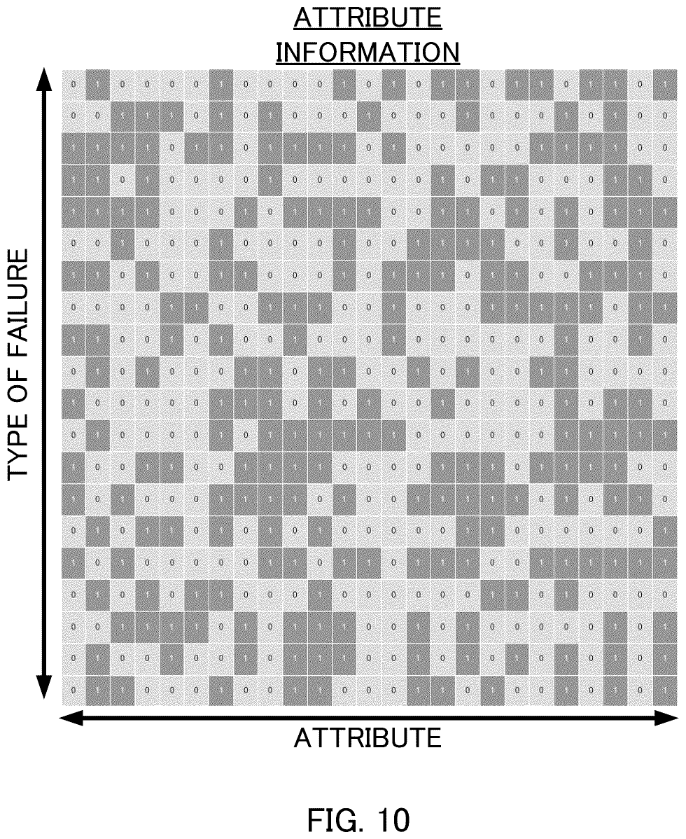

With reference to FIG. 9 and FIG. 10, the attribute information about the fault or failure used in the fault diagnosis operation described above will be described. FIG. 9 is a conceptual diagram illustrating a prediction operation of predicting the attribute information by the fault diagnosis system according to the fourth example embodiment. FIG. 10 is a diagram illustrating an example of the attribute information predicted by the fault diagnosis system according to the fourth example embodiment.

As illustrated in FIG. 9, the fault diagnosis system according to the fourth example embodiment is configured to predict N attributes (i.e., first to N-th attributes) in order to diagnose the unexperienced failure. The fault diagnosis system according to the fourth example embodiment includes a plurality of models corresponding to respective attributes. For example, it includes a first attribute prediction model for predicting the first attribute, a second attribute prediction model for predicting the second attribute, . . . , and an N-th attribute prediction model for predicting the Nth attribute. Each of the plurality of models includes a feature selection layer for selecting a feature and a classifier that predicts the attribute information. In the feature selection layer, as described in the first to third example embodiments, the learning is performed to perform the feature selection that increases the prediction accuracy of the classifier. The classifier may use the prediction layer used in the learning as it is, or may use another prediction layer.

As illustrated in FIG. 10, the fault diagnosis system 10 according to the fourth example embodiment stores the attribute information (an attribute vector) about the failure that may occur in the target device. This attribute information may be included in the input data. The attribute information is a vector including the attribute of the failure (a horizontal axis of the figure) and the type of the failure (a vertical axis of the figure). The fault diagnosis system 10 diagnoses the unexperienced failure by comparing the attribute vector with the attribute information predicted by the plurality of models. For example, a degree of similarity between each row of the attribute vector illustrated in FIG. 10 and the attribute information predicted by the plurality of models is calculated, and the type of the failure corresponding to the row with the highest degree of similarity is outputted as the type of the failure that occurs in the target device.

The fault diagnosis system 10 according to the fourth example embodiment performs the learning to allow the diagnosis of the unexperienced failure described above. The learning data in this case may be a sample set in which a pair of the time series operation data and a label (e.g., the attribute vector indicating the attribute information described above) is used as a sample. As for a specific technique/technology of the learning operation, it is possible to adopt those described in the first to third example embodiments, as appropriate.

### Technical Effect

Next, a technical effect of the learning method of the neural network executed in the fault diagnosis system 10 according to the fourth example embodiment will be described.

As described in FIG. 8 to FIG. 10, the fault diagnosis system 10 according to the fourth example embodiment is allowed to diagnose the experienced failure and the unexperienced failure. Furthermore, especially in this example embodiment, the model for diagnosing the unexperienced failure is learned in consideration of the reconstruction error, or the identification accuracy of the domain identification layer and the interdomain distance, and it is thus possible to predict the unexperienced failure with high accuracy.

### Fifth Example Embodiment

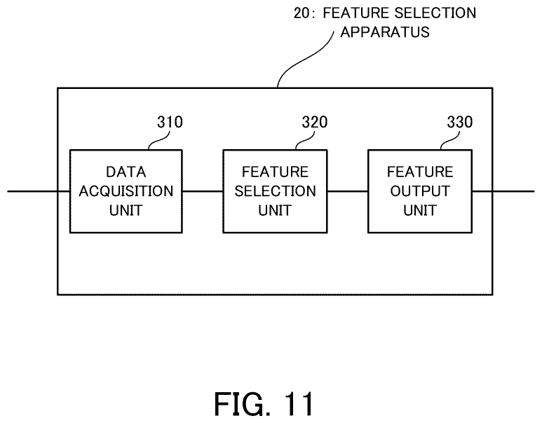

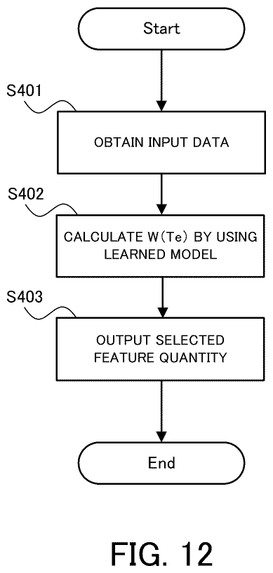

A feature selection apparatus according to a fifth example embodiment will be described with reference to FIG. 11 and FIG. 12. The fifth example embodiment describes the feature selection apparatus using the model described in the first to fourth example embodiments, and may be the same as the first to fourth example embodiments in the configuration and the learning method of the model. For this reason, a part that is different from each of the example embodiments described above will be described in detail below, and a description of other overlapping parts will be omitted as appropriate.

### (Apparatus Configuration)

First, with reference to FIG. 11, a configuration of the feature selection apparatus according to the fifth example embodiment will be described. FIG. 11 is a block diagram illustrating the configuration of the feature selection apparatus according to the fifth example embodiment.

As illustrated in FIG. 11, a feature selection apparatus 20 according to the fifth example embodiment includes, as components for realizing the function thereof, a data acquisition unit 310, a feature selection unit 320, and a feature output unit 330. Each of the acquisition unit 310, the feature selection unit 320, and the feature output unit 330 may be a processing block realized or implemented by the processor 11 (see FIG. 1), for example.

The data acquisition unit 310 is configured to obtain the input data inputted to the feature selection apparatus 20. The input data obtained by the data acquisition unit 310 are data including a plurality of features. The input data obtained by the data acquisition unit 310 may be data about the target device described in each of the example embodiments described above, or may be other data, for example.

The feature selection unit 320 is configured to select a part of the features from the input data obtained by the data acquisition unit 310. The feature selection unit 320 selects the feature by using a learned model. The learned model used by the feature selection unit 320 may be the model according to the other example embodiments already described.

The feature output unit 330 is configured to output the feature selected by the feature selection unit 320. That is, the feature output unit 330 outputs only the feature selected by the feature selection unit 320, of the plurality of features included in the input data obtained by the data acquisition unit 310. The feature output unit 330 may output the selected feature, for example, to an intermediate layer included in the model (neural network). Alternatively, the feature output unit 330 may output the selected feature to a storage apparatus or an external apparatus.

### (Feature Selection Operation)

Next, with reference to FIG. 12, a feature selection operation by the feature selection apparatus 20 according to the fifth example embodiment (i.e., an operation of selecting a part of the input data) will be described. FIG. 12 is a flow chart illustrating a flow of the feature selection operation performed by the feature selection apparatus according to the fifth example embodiment.

As illustrated in FIG. 12, when the operation of the feature selection apparatus 20 according to the fifth example embodiment is started, first, the data acquisition unit 310 obtains the input data (step S401). Subsequently, the feature selection unit 320 calculates W(Te) from the input data, by using the learned model (step S402). By this, it is determined which feature is selected from among the plurality of features included in the input data. Here, Tₑ is the final temperature determined in the earning.

Subsequently, the feature output unit 330 outputs the feature selected by calculating W(Te). That is, the feature output unit 330 outputs a node of a first layer assigned to a node of a second layer, as the selected feature. Specifically, the feature output unit 330 outputs {i|Σⱼwᵢⱼ(Tₑ)>0}, as the selected feature.

### Technical Effect

Next, a technical effect obtained by the feature selection apparatus 20 according to the fifth example embodiment will be described.

As described in FIG. 11 and FIG. 12, in the feature selection apparatus 20 according to the fifth example embodiment, a part of the features is selected from the input data, by using the learned model. The learned model is configured to select a feature with a high degree of importance at an output destination, from among the features included in the input data. Therefore, according to the feature selection apparatus 20 in this example embodiment, it is possible to select from the features included in the input data and output a more appropriate feature.

The feature selected by the function of each of the example embodiments described above (i.e., the feature selected by the learned model) may be used for the learning in the generation of another model. For example, the selected feature may be used in the generation of another identification model that is learned by a machine learning technique, which is different from the technique in this example embodiment. More specifically, the selected feature may be used for the learning of a support vector machine, a random forest, a naive Bayesian classifier, and the like. Then, the other model learned in this manner may be used for the classifier in the fault diagnosis system 10. That is, the model for performing an attribute classification may be a model separately learned by using the selected feature.

A processing method in which a program for allowing the configuration in each of the example embodiments to operate to realize the functions of each example embodiment is recorded on a recording medium, and in which the program recorded on the recording medium is read as a code and executed on a computer, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and executes process alone, but also the program that operates on an OS and executes process in cooperation with the functions of expansion boards and another software, is also included in the scope of each of the example embodiments. In addition, the program itself may be stored in a server, and a part or all of the program may be downloaded from the server to a user terminal.

### Supplementary Notes

The example embodiments described above may be further described as, but not limited to, the following Supplementary Notes.

### (Supplementary Note 1)

A method of learning a neural network according to Supplementary Note 1 is a method of learning a neural network, wherein the neural network includes: a feature selection layer for selecting a part of input data including information about a domain of each sample; a feature extraction layer for extracting a feature quantity on the basis of the selected input data; and a prediction layer for performing a prediction on the basis of the feature quantity, and the method includes adjusting a weight parameter of the neural network to increase a prediction accuracy by the prediction layer and to reduce a contribution to a prediction result of the prediction layer by the domain of the input data.

### (Supplementary Note 2)

A method of learning a neural network according to Supplementary Note 2 is the method of learning the neural network according to Supplementary Note 1, wherein the neural network further includes a domain identification layer for identifying the domain, a weight parameter of the domain identification layer is adjusted to increase an identification accuracy in the domain identification layer, and weight parameters of the feature selection layer and the feature extraction layer are adjusted to reduce the identification accuracy in the domain identification layer.

### (Supplementary Note 3)

A method of learning a neural network according to Supplementary Note 3 is the method of learning the neural network according to Supplementary Note 1, wherein the neural network further includes an interdomain distance calculation layer for calculating a degree of similarity between the domains, and weight parameters of the feature selection layer and the feature extraction layer are adjusted to increase the degree of similarity between the domains calculated in the interdomain distance calculation layer.

### (Supplementary Note 4)

A learning method of a neural network according to Supplementary Note 4 is the method of learning the neural network according to Supplementary Note 1, wherein the neural network further includes a domain identification layer for identifying the domain and an interdomain distance calculation layer for calculating a degree of similarity between the domain, a weight parameter of the domain identification layer is adjusted to increase an identification accuracy in the domain identification layer, and weight parameters of the feature selection layer and the feature extraction layer are adjusted to reduce the identification accuracy in the domain identification layer, and to increase the degree of similarity between the domains calculated in the interdomain distance calculation layer.

### (Supplementary Note 5)

A learning method of a neural network according to Supplementary Note 5 is the method of learning the neural network according to any one of Supplementary Notes 1 to 4, wherein the neural network further includes a partial reconstruction layer for reconstructing the selected input data on the basis of the feature quantity, and the weight parameter of the neural network is adjusted on the basis of a reconstruction error in the partial reconstruction layer.

### (Supplementary Note 6)

A learning method of a neural network according to Supplementary Note 6 is the method of learning the neural network according to any one of Supplementary Notes 1 to 4, wherein the input data include data obtained from a device and an attribute information about a failure that may occur in the device and a failure that has occurred in the device, the weight parameter of the neural network is adjusted to predict an unexperienced failure that has not occurred in the device, by using the data obtained from the device.

### (Supplementary Note 7)

A feature selection apparatus according to Supplementary Note 7 is a feature selection apparatus that performs learning to adjust a weight parameter of a neural network to increase a prediction accuracy by a prediction layer and to reduce a contribution to a prediction result of the prediction layer by a domain of input data, and that selects a part of the input data by using the learned neural network, wherein the neural network includes: a feature selection layer for selecting a part of input data including information about a domain of each sample; a feature extraction layer for extracting a feature quantity on the basis of the selected input data; and the prediction layer for performing a prediction on the basis of the feature quantity.

### (Supplementary Note 8)

A feature selection method according to Supplementary Note 8 is a feature selection method including: performing learning to adjust a weight parameter of a neural network to increase a prediction accuracy by a prediction layer and to reduce a contribution to a prediction result of the prediction layer by a domain of input data; and selecting a part of the input data by using the learned neural network, wherein the neural network includes: a feature selection layer for selecting a part of input data including information about a domain of each sample; a feature extraction layer for extracting a feature quantity on the basis of the selected input data; and the prediction layer for performing a prediction on the basis of the feature quantity.

### (Supplementary Note 9)

A computer program according to Supplementary Note 9 is a computer program that allows at least one computer to execute a method of learning a neural network, wherein the neural network includes: a feature selection layer for selecting a part of input data including information about a domain of each sample; a feature extraction layer for extracting a feature quantity on the basis of the selected input data; and a prediction layer for performing a prediction on the basis of the feature quantity, and the method includes adjusting a weight parameter of the neural network to increase a prediction accuracy by the prediction layer and to reduce a contribution to a prediction result of the prediction layer by the domain of the input data.

### (Supplementary Note 10)

A recording medium according to Supplementary Note 10 is a non-transitory recording medium on which a computer program that allows at least one computer to execute a method of learning a neural network is recorded, wherein the neural network includes: a feature selection layer for selecting a part of input data including information about a domain of each sample; a feature extraction layer for extracting a feature quantity on the basis of the selected input data; and a prediction layer for performing a prediction on the basis of the feature quantity, and the method includes adjusting a weight parameter of the neural network to increase a prediction accuracy by the prediction layer and to reduce a contribution to a prediction result of the prediction layer by the domain of the input data.

This disclosure is not limited to the above-described examples and is allowed to be changed, if desired, without departing from the essence or spirit of the invention which can be read from the claims and the entire specification. A learning method of a neural network, a feature selection apparatus, a feature selection method, a computer program, and a recording medium with such changes, are also included in the technical concepts of this disclosure.

### DESCRIPTION OF REFERENCE NUMERALS

10 Fault diagnosis system
11 Processor
14 Storage apparatus
20 Feature selection apparatus
110 Data collection unit
120 Learning unit
130 Prediction unit
140 Output unit
150 Storage unit
210 Feature selection layer
220 Feature extraction layer
230 Partial reconstruction layer
240 Prediction layer
250 Domain identification layer
260 Gradient inversion layer
270 Interdomain distance calculation layer
310 Data acquisition unit
320 Feature selection unit
330 Feature output unit

What is claimed is:

1. A method of learning a neural network, wherein
the neural network includes:
a feature selection layer for selecting a part of input data including information about a domain of each sample;
a feature extraction layer for extracting a feature quantity on the basis of the selected input data; and
a prediction layer for performing a prediction on the basis of the feature quantity, and
the method comprises adjusting a weight parameter of the neural network to increase a prediction accuracy by the prediction layer and to reduce a contribution to a prediction result of the prediction layer by the domain of the input data.

2. The method of learning the neural network according to claim 1, wherein
the neural network further includes a domain identification layer for identifying the domain,
a weight parameter of the domain identification layer is adjusted to increase an identification accuracy in the domain identification layer, and
weight parameters of the feature selection layer and the feature extraction layer are adjusted to reduce the identification accuracy in the domain identification layer.

3. The method of learning the neural network according to claim 1, wherein
the neural network further includes an interdomain distance calculation layer for calculating a degree of similarity between the domains, and
weight parameters of the feature selection layer and the feature extraction layer are adjusted to increase the degree of similarity between the domains calculated in the interdomain distance calculation layer.

4. The method of learning the neural network according to claim 1, wherein
the neural network further includes a domain identification layer for identifying the domain and an interdomain distance calculation layer for calculating a degree of similarity between the domain,
a weight parameter of the domain identification layer is adjusted to increase an identification accuracy in the domain identification layer, and
weight parameters of the feature selection layer and the feature extraction layer are adjusted to reduce the identification accuracy in the domain identification layer, and to increase the degree of similarity between the domains calculated in the interdomain distance calculation layer.

5. The method of learning the neural network according to claim 1, wherein
the neural network further includes a partial reconstruction layer for reconstructing the selected input data on the basis of the feature quantity, and
the weight parameter of the neural network is adjusted on the basis of a reconstruction error in the partial reconstruction layer.

6. The method of learning the neural network according to claim 1, wherein
the input data include data obtained from a device and an attribute information about a failure that may occur in the device and a failure that has occurred in the device,
the weight parameter of the neural network is adjusted to predict an unexperienced failure that has not occurred in the device, by using the data obtained from the device.

7. A feature selection apparatus that performs learning to adjust a weight parameter of a neural network to increase a prediction accuracy by a prediction layer and to reduce a contribution to a prediction result of the prediction layer by a domain of input data, and that selects a part of the input data by using the learned neural network, wherein
the neural network includes:
a feature selection layer for selecting a part of input data including information about a domain of each sample;
a feature extraction layer for extracting a feature quantity on the basis of the selected input data; and
the prediction layer for performing a prediction on the basis of the feature quantity.

8. A feature selection method comprising:
performing learning to adjust a weight parameter of a neural network to increase a prediction accuracy by a prediction layer and to reduce a contribution to a prediction result of the prediction layer by a domain of input data; and
selecting a part of the input data by using the learned neural network, wherein
the neural network includes:
a feature selection layer for selecting a part of input data including information about a domain of each sample;
a feature extraction layer for extracting a feature quantity on the basis of the selected input data; and
the prediction layer for performing a prediction on the basis of the feature quantity.
